(19) United States
(12) Patent Application Publication
(10) Pub. No.: US 2024/0045456 A1
(43) Pub. Date: Feb. 8, 2024

(54) NOISE CANCELLATION FOR POWER SUPPLY REJECTION

(71) Applicant: Advanced Micro Devices, Inc., Santa Clara, CA (US)

(72) Inventors: Onn Lim Yong, Ft. Collins, CO (US); Luca Ravezzi, San Francisco, CA (US); Naman Parashar, Ft. Collins, CO (US); Jeremy Zaks Walker, San Jose, CA (US)

(21) Appl. No.: 17/883,216

(22) Filed: Aug. 8, 2022

(51) Int. Cl. G05F 1/575

(52) U.S. Cl. CPC G05F 1/575

(57) ABSTRACT

A method for regulating a supply voltage includes generating an output voltage on an output power supply node based on an input voltage on an input power supply node and a control signal on a control node of a common drain amplifier. The method includes generating the control signal using a mirrored current generated based on the input voltage. The mirrored current may be generated using a noise-compensating capacitor having a capacitance C_{NC}, thereby compensating for a noise current generated by a parasitic gate-to-drain capacitance of the common drain amplifier based on the input voltage. The capacitance C_{NC} may be approximately equal to 1/N times a parasitic gate-to-drain capacitance of the common drain amplifier, where N is greater than one. The current may be further based on a difference between a reference voltage and the output voltage on the output power supply node.

### BACKGROUND

### Description of the Related Art

In general, integrated circuits and systems-on-a-chip (SOCs) include circuits that are sensitive to power supply voltage variations and noise. A conventional low dropout regulator circuit regulates an output voltage based on a power supply voltage using an n-type metal-oxide semiconductor (NMOS) common drain (i.e., source-follower) input pole dominant design that is compensated using a compensation capacitor. Referring to FIG. 1, voltage regulator 100 regulates input voltage VDDIREG on an input power supply node to generate output voltage VDDREG on an output power supply node. Voltage regulator 100 includes feedback amplifier 102 that generates an output signal in response to a differential input signal based on a difference between output voltage VDDREG and reference voltage VREF. Voltage regulator 100 includes compensation capacitor 106 having capacitance C_{COMP} to prevent feedback amplifier 102 from oscillating and to create a dominant pole with a target magnitude. However, a parasitic gate-to-drain capacitance of NMOS common drain amplifier 104 injects noise from the input power supply node onto the output node via the gate terminal of NMOS common drain amplifier 104. The injected noise degrades a power supply rejection ratio (i.e., the ability to suppress power supply variations) of voltage regulator 100, which degrades performance of sensitive circuits. Although compensation capacitor 106 can be increased to reduce or eliminate the noise injected to the gate terminal, increasing compensation capacitor 106 lowers the loop bandwidth of the circuit and degrades performance of voltage regulator 100. Accordingly, improved techniques for regulating voltage are desired.

### SUMMARY OF EMBODIMENTS OF THE INVENTION

In at least one embodiment, a method for regulating a supply voltage includes generating an output voltage on an output power supply node based on an input voltage on an input power supply node and a control signal on a control node of a common drain amplifier, thereby compensating for a noise current generated by a parasitic gate-to-drain capacitance of the common drain amplifier based on the input voltage. The method includes generating the control signal using a mirrored current generated based on the input voltage. The mirrored current may be generated using a noise-compensating capacitor having a capacitance C_{NC}. The capacitance C_{NC} may be approximately equal to 1/N times a gate-to-drain capacitance of the common drain amplifier, where N is greater than one. The current may be further based on a difference between a reference voltage and the output voltage on the output power supply node.

In at least one embodiment, a voltage regulator includes a common drain amplifier configured to provide an output voltage to an output power supply node based on an input voltage on an input power supply node and a control signal on a control node. The voltage regulator includes a compensation capacitor coupled to the control node, a current mirror configured to provide a current through the control node, and a noise-compensating capacitor having a first terminal coupled to the input power supply node and a second terminal coupled to a gate node of the current mirror. The current may adjust a voltage on the control node based on the input voltage on the input power supply node thereby compensating for noise injected by a parasitic gate-to-drain capacitance of the common drain amplifier based on the input voltage.

In an embodiment, a voltage regulator includes a common drain amplifier coupled to an input power supply node and an output power supply node. The voltage regulator includes an operational transconductance amplifier configured to provide a control signal to a control terminal of the common drain amplifier. The operational transconductance amplifier includes a differential amplifier configured to generate a difference signal based on a difference between a reference voltage and an output voltage on the output power supply node. The operational transconductance amplifier includes a current mirror configured to generate the control signal based on the difference signal. The operational transconductance amplifier includes a noise-compensating capacitor having a first terminal coupled to the input power supply node and a second terminal coupled to gate node of the current mirror.

### BRIEF DESCRIPTION OF THE DRAWINGS

The present invention may be better understood, and its numerous objects, features, and advantages made apparent to those skilled in the art by referencing the accompanying drawings.

FIG. 1 illustrates a functional block diagram of a conventional voltage regulator including a common drain amplifier.

FIG. 2 illustrates a functional block diagram of a voltage regulator including a common drain amplifier with noise cancellation for power supply rejection consistent with at least one embodiment of the invention.

FIG. 3 illustrates a functional block diagram of a current mirror circuit for use in an embodiment of the voltage regulator of FIG. 2.

FIG. 4 illustrates a functional block diagram of a voltage regulator including a common drain amplifier with a noise cancellation circuit for power supply rejection integrated in a feedback amplifier consistent with at least one embodiment of the invention.

FIG. 5 illustrates a circuit diagram of a feedback amplifier integrating a noise cancellation circuit with an n-type current mirror consistent with at least one embodiment of the invention.

FIG. 6 illustrates a circuit diagram of a feedback amplifier integrating a noise cancellation circuit with a p-type current mirror consistent with at least one embodiment of the invention.

FIG. 7 illustrates waveforms of power supply feedthrough as a function of normalized frequency for a voltage regulator including a disabled noise compensation circuit and for the voltage regulator including an enabled noise compensation circuit consistent with an embodiment of the invention.

FIG. 8 illustrates a circuit diagram of a complementary circuit for the feedback amplifier of FIG. 5.

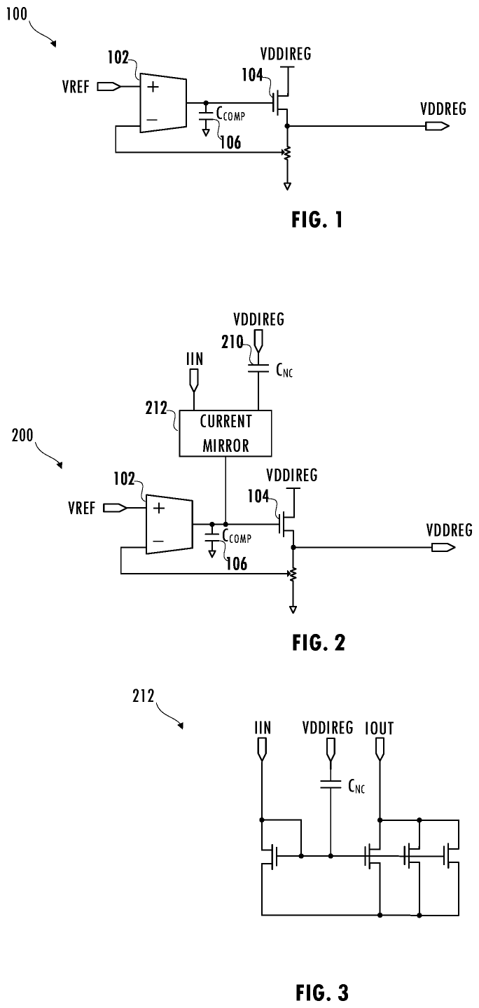

The use of the same reference symbols in different drawings indicates similar or identical items.

### DETAILED DESCRIPTION

A technique for counteracting noise injected from the input power supply node to the gate terminal of an NMOS common drain amplifier of a voltage regulator includes a noise-compensating circuit that introduces a path from the input power supply node to the gate terminal of the NMOS common drain amplifier. Referring to FIG. 2, in at least one embodiment of voltage regulator 200, feedback amplifier 102 generates an output signal in response to a differential input signal based on a difference between output voltage VDDREG and reference voltage VREF. In at least one embodiment of voltage regulator 200, noise-compensating capacitor 210 is coupled between the input power supply node that receives input voltage VDDIREG, and a gate terminal of current mirror 212. The output node of current mirror 212 is coupled to the compensation node of feedback amplifier 102 and the gate terminal of common drain amplifier 104. The current provided by current mirror 212 is 180 degrees out of phase with a current injected by the parasitic gate-to-drain capacitance of common drain amplifier 104, thereby attenuating or eliminating an effect on the output voltage of a disturbance on the input power supply node.

In at least one embodiment, current mirror 212 has a unary mirror gain and capacitance C_{NC} is approximately the same as the parasitic gate-to-drain capacitance of common drain amplifier 104. In at least one embodiment, current mirror 212 has a mirror gain that is greater than one, i.e., current mirror 212 generates an output current that is N/M times the input current, where N is the total width of the transistors coupled to the output node of current mirror 212, M is the total width of the transistors coupled to the input node of current mirror 212, and N/M is greater than one. Accordingly, capacitance C_{NC} is less than the parasitic gate-to-drain capacitance of common drain amplifier 104 (e.g., capacitance C_{NC} is M/N times the parasitic gate-to-drain capacitance of common drain amplifier 104). Referring to FIG. 3, in an embodiment, current mirror 212 has a mirror gain of three. Note that the current mirror of FIG. 3 is exemplary only and other current mirror circuits with other mirror gain values may be used. For example, in other embodiments, current mirror 212 may be formed using PMOS transistors. In at least one embodiment, the current mirror includes at least one cascode transistor coupled in series with the output transistor(s). In other embodiments, current mirror 212 or amplifier 102 include compensation for a voltage offset that would otherwise be introduced by the circuit of FIG. 3. For example, an embodiment of current mirror 212 is coupled to a p-type metal-oxide semiconductor (PMOS) current source with an output coupled to the output node of current mirror 212 and having a nominal value that is equal to the current produced by current mirror 212 at DC.

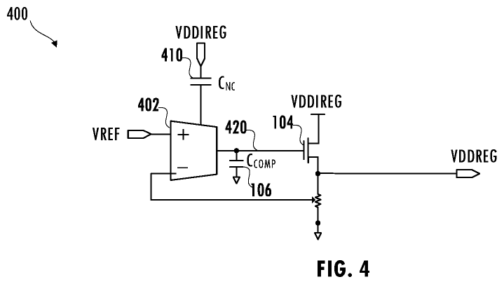

Referring to FIG. 4, in at least one embodiment of voltage regulator including a noise-compensating circuit for improving power supply rejection, feedback amplifier 402 incorporates a current mirror circuit coupled to node 420. Accordingly, an additional current mirror circuit is not needed and noise-compensating capacitor 410 is coupled directly to the current mirror at the output of feedback amplifier 402. The component of the mirrored current provided by the noise-compensating circuit including capacitor 410 is 180 degrees out of phase with a current injected by the parasitic gate-to-drain capacitance of common drain amplifier 104, thereby attenuating or eliminating an effect on the output voltage of a disturbance on the input power supply node. The use of a current mirror circuit included in feedback amplifier 402 for noise-cancellation in the embodiment of FIG. 4 reduces circuit area and product cost and reduces power consumption of embodiments of voltage regulator 400 as compared to embodiments of voltage regulator 200 of FIG. 2.

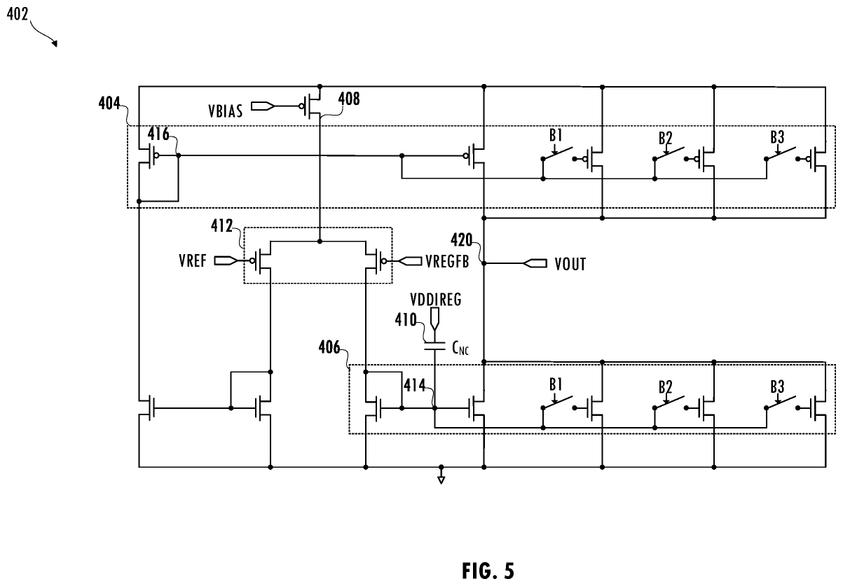

Referring to FIG. 4, in at least one embodiment of voltage regulator 400, feedback amplifier 402 is an operational transconductance amplifier that generates an output current in response to the differential input voltage based on the difference between output voltage VDDREG and reference voltage VREF. Referring to FIG. 5, feedback amplifier 402 is an operational transconductance amplifier that includes an input differential pair of PMOS transistors 412 coupled to PMOS current source 408, PMOS current mirror 404, and NMOS current mirror 406. In an embodiment, the mirror gains of PMOS current mirror 404 and NMOS current mirror 406 are selectable using switches and corresponding control signals B1, B2, and B3. In other embodiments, the mirror gain is fixed. Noise-compensating capacitor 410 is coupled between the input power supply node and gate node 414 of NMOS current mirror 406. The component of the mirrored current provided by the noise-compensating circuit including capacitor 410 is 180 degrees out of phase with a current injected by the parasitic gate-to-drain capacitance of common drain amplifier 104, thereby attenuating or eliminating an effect on the output voltage of a disturbance on the input power supply node. As noise on the input power supply node increases input voltage VDDIREG, the noise compensation circuit increases the voltage on gate node 414, thereby increasing the current output by NMOS current mirror 406 and decreasing output voltage VOUT on node 420, which is coupled to the gate terminal of the common drain amplifier.

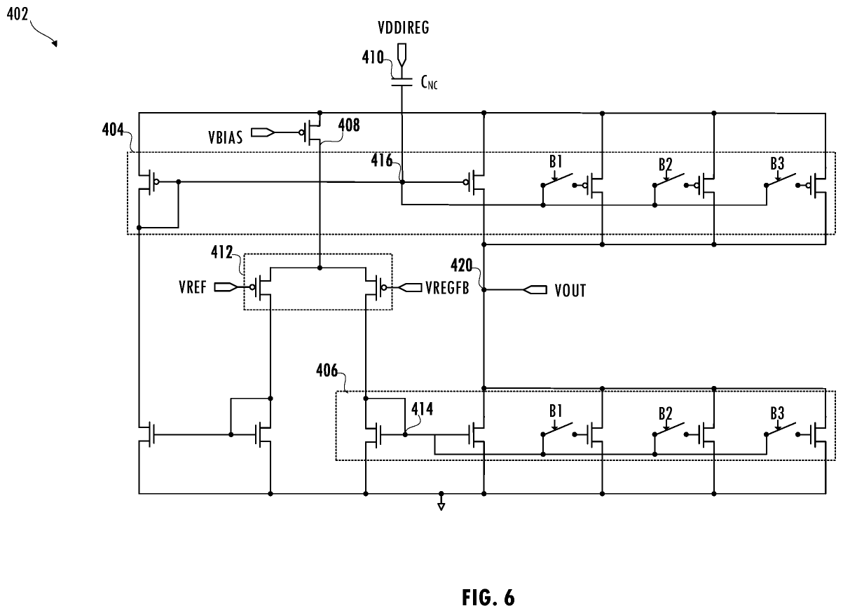

Referring to FIG. 6, in other embodiments of feedback amplifier 402, noise-compensating capacitor 410 is coupled between the input power supply node and the gate node 416 of PMOS current mirror 404. The component of the mirrored current provided by the noise-compensating circuit including capacitor 410 is 180 degrees out of phase with a current injected by the parasitic gate-to-drain capacitance of common drain amplifier 104, thereby attenuating or eliminating an effect on the output voltage of a disturbance on the input power supply node. As noise increases input voltage VDDIREG on the input power supply node, the noise compensation circuit increases the voltage on node 416, thereby reducing the current output by PMOS current mirror 404 and decreasing the voltage on node 420. Note that the operational transconductance amplifier topologies of FIGS. 5 and 6 are exemplary only. Techniques described herein are applicable for use with other operational transconductance amplifier topologies (e.g., multi-stage operational transconductance amplifiers, folded cascode operational transconductance amplifiers, and telescopic operational transconductance amplifiers).

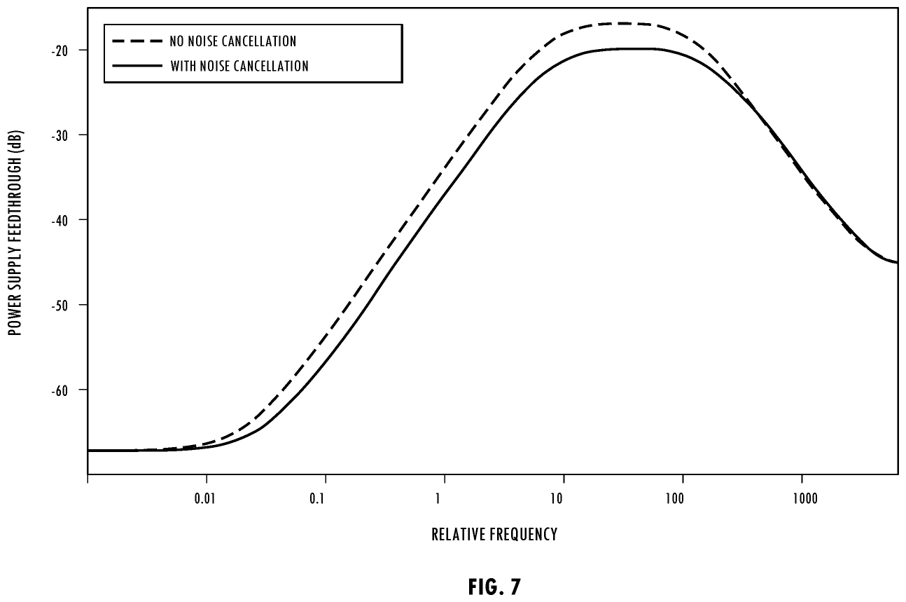

FIG. 7 illustrates waveforms of a small-signal simulation of power supply feedthrough as a function of normalized frequency for a voltage regulator having the noise compensation circuit disabled and for a voltage regulator having the noise compensation technique enabled consistent with an embodiment of the invention. The noise compensation technique improves the power supply rejection of the voltage regulator by approximately 3 dB over the bandwidth of the amplifier. Note that at the edge of the correction circuit bandwidth (e.g., at a relative frequency between 10 and 100), the ability to correct for power supply noise rolls off.

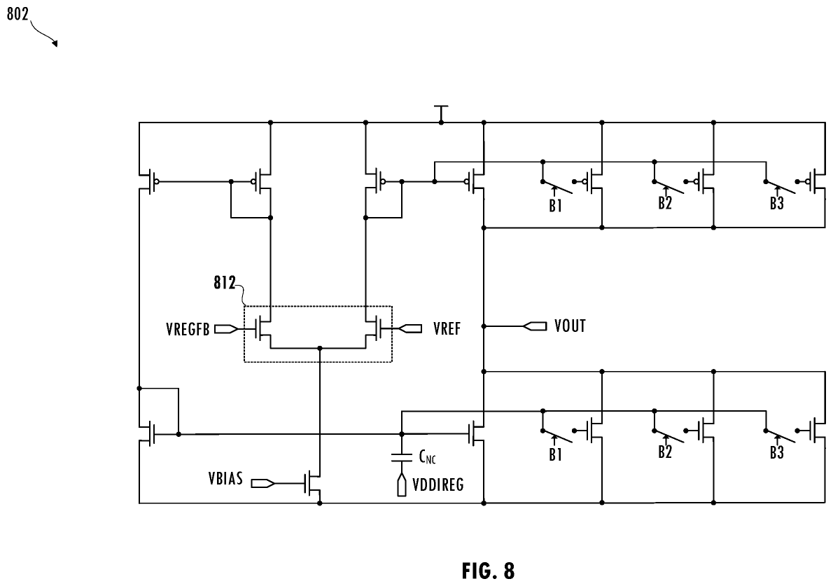

Thus, techniques for reducing noise and improving power supply rejection and bandwidth of a voltage regulator are disclosed. The techniques reduce the need for increasing a compensation capacitance of a feedback amplifier to address the noise injection. The description of the invention set forth herein is illustrative and is not intended to limit the scope of the invention as set forth in the following claims. For example, while the invention has been described in an embodiment in which the feedback amplifier includes a PMOS input pair of transistors, one of skill in the art will appreciate that the teachings herein can be utilized with a feedback amplifier including an NMOS input pair of transistors, as illustrated by input differential pair of NMOS transistors 812 in feedback amplifier 802 of FIG. 8. The terms “first,” “second,” “third,” and so forth, as used in the claims, unless otherwise clear by context, is to distinguish between different items in the claims and does not otherwise indicate or imply any order in time, location or quality. For example, “a first received signal,” “a second received signal,” does not indicate or imply that the first received signal occurs in time before the second received signal. Variations and modifications of the embodiments disclosed herein may be made based on the description set forth herein, without departing from the scope of the invention as set forth in the following claims.

1. A method for regulating a supply voltage, the method comprising:
generating an output voltage on an output power supply node based on an input voltage on an input power supply node and a control signal on a control node of a common drain amplifier; and
generating the control signal using a mirrored current provided to the control node of the common drain amplifier and generated based on the input voltage, thereby compensating for a noise current generated by a parasitic gate-to-drain capacitance of the common drain amplifier based on the input voltage,
wherein generating the control signal comprises:
generating a current through an output node of a differential pair of transistors based on a reference signal and a feedback signal;
mirroring the current through the output node using a current mirror to generate the mirrored current; and
capacitively coupling the input power supply node to a gate node of the current mirror and the output node of the differential pair of transistors.

2. The method as recited in claim 1 wherein capacitively coupling uses a noise-compensating capacitor having a capacitance C_{NC}.

3. The method as recited in claim 2 wherein the capacitance C_{NC} is linearly related to 1/N times the parasitic gate-to-drain capacitance of the common drain amplifier, where N is greater than one.

4. The method as recited in claim 1 wherein the control signal is further based on a difference between a reference voltage and the output voltage on the output power supply node.

5. (canceled)

6. The method as recited in claim 1 wherein the control signal is generated by capacitively coupling the current mirror within an operational transconductance amplifier to the input power supply node.

7. The method as recited in claim 1 wherein the mirrored current is positively related to noise on the input power supply node.

8. The method as recited in claim 1 wherein the mirrored current is negatively related to noise on the input power supply node.

9. A voltage regulator comprising:
a common drain amplifier configured to provide an output voltage to an output power supply node based on an input voltage on an input power supply node and a control signal on a control node of the common drain amplifier;
a compensation capacitor coupled to the control node;
a differential pair of transistors configured to generate a current based on a reference signal and a feedback signal;
a current mirror configured to mirror the current and provide a mirrored current to the control node; and
a noise-compensating capacitor having a first terminal coupled to the input power supply node and a second terminal coupled to a gate node of the current mirror and an output node of the differential pair of transistors.

10. The voltage regulator as recited in claim 9 wherein the mirrored current adjusts a voltage on the control node based on the input voltage on the input power supply node thereby compensating for noise injected by a parasitic gate-to-drain capacitance of the common drain amplifier based on the input voltage.

11. The voltage regulator as recited in claim 9, further comprising:
a feedback amplifier including the differential pair of transistors and being configured to provide the control signal to the control node based on a difference between a reference voltage and the output voltage.

12. The voltage regulator as recited in claim 11 wherein the feedback amplifier is an operational transconductance amplifier comprising the differential pair of transistors, the current mirror, and the noise-compensating capacitor.

13. The voltage regulator as recited in claim 11 wherein the current mirror and capacitor are external to the feedback amplifier.

14. The voltage regulator as recited in claim 9 wherein the common drain amplifier includes an n-type transistor having a source terminal coupled to the output power supply node, a drain terminal coupled to the input power supply node, and a gate terminal coupled to the control node.

15. The voltage regulator as recited in claim 9 wherein the common drain amplifier includes an n-type transistor in a common drain configuration and the current mirror comprises n-type transistors and provides the mirrored current having a positive relationship to noise on the input power supply node.

16. The voltage regulator as recited in claim 9 wherein the common drain amplifier includes an n-type transistor in a common drain configuration and the current mirror comprises p-type transistors and provides the mirrored current having a negative relationship to noise on the input power supply node.

17. The voltage regulator as recited in claim 9 wherein the noise-compensating capacitor has a capacitance C_{NC} and the noise-compensating capacitor has an effective capacitance at the control node of N×C_{NC}, where N is greater than one.

18. The voltage regulator as recited in claim 17 wherein the capacitance C_{NC} is linearly related to 1/N times a parasitic gate-to-drain capacitance of the common drain amplifier.

19. A voltage regulator comprising:
a common drain amplifier coupled to an input power supply node and an output power supply node; and
an operational transconductance amplifier configured to provide a control signal to a control terminal of the common drain amplifier, the operational transconductance amplifier comprising:
a differential amplifier configured to generate a difference signal through an output node of the differential amplifier based on a difference between a reference voltage and an output voltage on the output power supply node;
a current mirror configured to provide to the control terminal a mirrored current based on the difference signal; and
a noise-compensating capacitor having a first terminal coupled to the input power supply node and a second terminal coupled to a gate node of the current mirror and the output node of the differential amplifier.

20. The voltage regulator as recited in claim 19 wherein the noise-compensating capacitor has a capacitance C_{NC} and the noise-compensating capacitor has an effective capacitance at the control terminal linearly related to N×C_{NC}, where N is greater than one.

21. The method as recited in claim 1 further comprising:
generating the mirrored current to be N/M times an input current, where N is a first total width of first transistors coupled to an output node of the current mirror and M is a second total width of second transistors coupled to an input node of the current mirror, and N/M is greater than one, the first transistors having a first source and drain doping type and the second transistors having a second source and drain doping type; and
selectively adjusting the first total width of the first transistors coupled to the output node of the current mirror, thereby adjusting an amount of noise compensation.

22. The voltage regulator as recited in claim 9,
wherein the mirrored current is N/M times an input current of the current mirror, where N is a first total width of first transistors coupled to an output node of the current mirror and M is a second total width of second transistors coupled to an input node of the current mirror, and N/M is greater than one, the first transistors having a first source and drain doping type and the second transistors having a second source and drain doping type, and
wherein the current mirror comprises switches coupled to corresponding transistors of the first transistors and configured to select the first total width of the first transistors coupled to the output node of the current mirror and thereby select an amount of noise compensation.
